(19) United States
(12) Patent Application Publication
(10) Pub. No.: US 2026/0263973 A1
(43) Pub. Date: Sep. 10, 2026

(54) POWDERED ADSORBENT LOSSLESS RECOVERY METHOD BASED ON BELT FILTER

(71) Applicant: Zhejiang Yongzheng Lithium Technology Co., Ltd., Quzhou City (CN)

(72) Inventors: Kai ZHANG, Quzhou City (CN); Guotai SHAO, Quzhou City (CN); Hao JIANG, Quzhou City (CN); Yiran LI, Quzhou City (CN); Junyao MA, Quzhou City (CN); Dongnan GU, Quzhou City (CN)

(73) Assignee: Zhejiang Yongzheng Lithium Technology Co., Ltd., Quzhou City (CN)

(21) Appl. No.: 19/318,650

(22) Filed: Sep. 4, 2025

(30) Foreign Application Priority Data
Mar. 10, 2025 (CN) 202510275774.3

(51) Int. Cl. B01D 33/48; B01D 33/01; B01D 33/58; C02F 1/00; C02F 1/28

(52) U.S. Cl. CPC B01D 33/48; B01D 33/0183; B01D 33/58; C02F 1/004; C02F 1/28; B01D 2201/087; C02F 2303/16; C02F 2303/18

(57) ABSTRACT

A powdered adsorbent lossless recovery method based on a belt filter is provided. The lossless recovery method includes a first separation step of collecting a powdered adsorbent at a tail end of a belt filter. In the first separation step, at least a gas-water mixture fluid is used to flush a filter cloth to separate the powdered adsorbent from the filter cloth. In this disclosure, the separation manner of simple water washing used in the conventional technology is replaced with the manner that a gas-water mixture fluid is used to flush a filter cloth. Such a separation manner can not only save a large amount of liquid, but also reduce water content in a flushed powdered adsorbent suspension, so that the leakage of the powdered adsorbent is greatly reduced during transportation, to improve the recovery rate of the powdered adsorbent.

### INCORPORATION BY REFERENCE

The present application claims priority to Chinese Application No. 202510275774.3 filed on Mar. 10, 2025 and entitled “Powdered Adsorbent Lossless Recovery Method Based on Belt Filter”, the disclosure of which is incorporated herein by reference in its entirety.

### TECHNICAL FIELD

This disclosure belongs to the field of water treatment technologies, and in particular, relates to a powdered adsorbent lossless recovery method based on/from a belt filter.

### BACKGROUND

At present, it is an effective method to treat brine with a vacuum belt filter (hereinafter referred to as a belt filter) combined with a powdered adsorbent (for example, Chinese Patent Publication No. CN111825152B discloses a belt filter and an application thereof in extraction of lithium from brine by adsorption). The powdered adsorbent is a key raw material for brine treatment, and investment costs are high. Therefore, it is extremely important to recover the powdered adsorbent at a tail end of the belt filter without loss.

To resolve this problem, Chinese Patent Publication No. CN115261639B discloses a lossless recovery method, a lossless recovery apparatus, and a lossless recycling system of a powdered adsorbent for extracting lithium from brine. The lossless recovery method includes: collecting a powdered adsorbent at a tail end of a belt filter, where the powdered adsorbent is separated from the belt filter by scraping and water washing; the collected powdered adsorbent is conveyed to a mixing adsorption tank at a head end of the belt filter by using a hoister, where the powdered adsorbent is separated from the hoister by water washing; and the hoister is disposed between a tail end of one belt filter and a head end of another belt filter, and the two hoisters connect the two belt filters in series.

It may be learned that, in the recycling method, the powdered adsorbent needs to be separated from a filter cloth by water washing. However, to adequately wash all the powdered adsorbent from the filter cloth, a water flow rate is generally large. This not only wastes a large amount of a water washing solution, but also causes excessive water content of the adsorbent on the hoister, which is not conducive to large-slope hoisting. In addition, there will be a lot of loss of the adsorbent and large leakage.

### SUMMARY

An objective of this disclosure is to provide a powdered adsorbent lossless recovery method based on a belt filter, to reduce the loss of a powdered adsorbent in a recycling method.

To achieve the foregoing objective of this disclosure, this disclosure provides the following technical solution:

A powdered adsorbent lossless recovery method based on a belt filter includes a first separation step of collecting a powdered adsorbent at a tail end of a belt filter. The first separation step includes flushing a filter cloth with at least a gas-water mixture fluid to separate the powdered adsorbent from the filter cloth.

In this disclosure, the separation manner of simple water washing used in the conventional technology is discarded, but the filter cloth is flushed with a gas-water mixture fluid. Such a separation manner can not only save a large amount of liquid, but also reduce water content in a flushed powdered adsorbent suspension, so that the leakage of the powdered adsorbent is greatly reduced during transportation, to improve the recovery rate of the powdered adsorbent.

Preferably, in the foregoing powered adsorbent lossless recovery method, a gas-water mixture distributor is configured to distribute the gas-water mixture fluid to the filter cloth, the gas-water mixture distributor includes at least one distribution pipe, the distribution pipe is disposed on a rotation path of the filter cloth and is located on an inner side of the filter cloth, and a plurality of distribution holes for spraying the gas-water mixture fluid to the filter cloth are disposed on the distribution pipe.

Flushing from the inner side can further promote rapid separation of the powdered adsorbent from the filter cloth. The gas-water mixture fluid sprayed from the distribution holes may be sprayed intermittently or continuously, which is not specifically required in this disclosure, and depends on distribution of the powdered adsorbent on the filter cloth. When intermittent spraying is used, a spraying area can be also ensured by disposing more ejection pipes.

In this disclosure, the distribution pipe may be disposed in a state of being close to or pressing against the filter cloth, or may be disposed in a state of tensioning the filter cloth. In the state of tensioning the filter cloth, the filter cloth can be flushed while changing the running direction (giving a certain stripping force to the powdered adsorbent), so that the separation effect is better.

Preferably, in the foregoing powdered adsorbent lossless recovery method, in the gas-water mixture fluid, a gas flow rate is 0.2 m³/h to 0.5 m³/h, and a liquid flow rate is 0.8 m³/h to 2.0 m³/h. More preferably, the gas flow rate is 0.3 m³/h to 0.5 m³/h, and the liquid flow rate is 1 m³/h to 1.5 m³/h. At these fluid flow rate, the recovery rate of the adsorbent can be more than 99%.

The powdered adsorbent lossless recovery method of this disclosure has no special requirement on the type of the gas used in the gas-water mixture fluid. Any gas may be used in this disclosure. Compressed air is relatively preferred because the costs are low. A used liquid may be a stock solution (that is, a brine stock solution to be processed by the belt filter) or a desorption solution (that is, a desorption solution to be used by the belt filter in a desorption phase), and the stock solution is relatively preferred. In this way, a powdered adsorbent suspension left on the filter cloth has the same composition when it is returned to the head end of the belt filter and used again.

Preferably, the powdered adsorbent lossless recovery method in this disclosure further includes a hoisting step of conveying the collected powdered adsorbent to a head end of the same belt filter by using a hoister. Preferably, in the foregoing powdered adsorbent lossless recovery method, the hoister includes a rack and a conveyor belt that runs cyclically on the rack; the conveyor belt includes a return section below the belt filter, a reuse section above the head end of the belt filter, and a hoisting section connected to the return section and the reuse section; and a running direction of the return section is consistent with a rotation direction of the filter cloth, and a running direction of the reuse section is consistent with a forward direction of the filter cloth.

In this disclosure, the hoister is disposed in a half-enclosed manner on an outer circumference of the belt filter, has a compact structure and a small occupation volume, and can implement adsorbent recycling of a single belt filter.

Further preferably, in the foregoing powdered adsorbent lossless recovery method, a plurality of material stoppers/cleats sequentially arranged in a running direction of the conveyor belt are disposed on a surface of the conveyor belt, material accumulation troughs are formed between the material stoppers and the conveyor belt, and an included angle between each of the material stoppers and the conveyor belt is 30° to 60°.

Further preferably, in the foregoing powdered adsorbent lossless recovery method, a running speed of the filter cloth is 0.5 m/min to 3 m/min, and a running speed of the conveyor belt is greater than 5 m/min. A proper running speed of the filter cloth is for avoiding cross-flow of water between work sections (a solid-liquid separation zone, a smoke removal zone, and a desorption zone) of the belt filter, and the high running speed of the conveyor belt can improve recovery efficiency of the adsorbent.

Preferably, the foregoing powdered adsorbent lossless recovery method further includes a second separation step of separating the powdered adsorbent from the hoister.

In the second separation step, the conveyor belt of the hoister is flushed with a liquid or a gas-water mixture fluid.

Further preferably, in the foregoing powdered adsorbent lossless recovery method, a collection hopper for receiving the powdered adsorbent dropped from the reuse section is disposed on the rack at the head end of the belt filter; and the top opening width of the collection hopper is equivalent to the length of the reuse section, and a flushing pipe for flushing the powdered adsorbent from the reuse section and/or the collection hopper is disposed on the collection hopper.

In this way, as long as the powdered adsorbent suspension is transferred from the hoisting section to the reuse section, the powdered adsorbent suspension is collected by the collection hopper without disorderly flowing down. Residues on the conveyor belt and/or the collection hopper are flushed by the flushing pipe. A flushing fluid used by the flushing pipe may be a liquid (for example, a stock solution), or may be a gas-water mixture fluid, which is not required in this disclosure.

It should be noted that, because the material stoppers are disposed on the surface of the conveyor belt, it is necessary to pay more attention to a flushing angle of the flushing pipe, that is, the flushing direction of at least one flushing pipe needs to be opposite to the running direction of the conveyor belt, so as to flush the material accumulation troughs as much as possible.

Compared with the conventional technology, this disclosure has the following beneficial effects:

In this disclosure, a separation manner of simple water washing used in the conventional technology is discarded, but the filter cloth is flushed with the gas-water mixture fluid. Such a separation manner can not only save a large amount of liquid, but also reduce water content in a flushed powdered adsorbent suspension, so that the leakage of the powdered adsorbent is greatly reduced during transportation, to improve the recovery rate of the powdered adsorbent.

In this disclosure, the distribution pipe of the gas-water mixture distributor is disposed on the rotation path of the filter cloth and is located on the inner side of the filter cloth, and flushing from the inner side can further promote rapid separation of the powdered adsorbent from the filter cloth. In addition, the distribution pipe may be disposed in a state of being close to or pressing against the filter cloth, or may be disposed in a state of tensioning the filter cloth. In the state of tensioning the filter cloth, the filter cloth can be flushed while changing the running direction (giving a certain stripping force to the powdered adsorbent), so that the separation effect is better.

In this disclosure, the hoister is disposed in a half-enclosed manner on an outer circumference of the belt filter, has a compact structure and a small occupation volume, and can implement adsorbent recycling of a single belt filter.

### BRIEF DESCRIPTION OF DRAWINGS

FIG. 1 is a schematic structural diagram of a device used in a powdered adsorbent lossless recovery method based on a belt filter according to this disclosure;

FIG. 2 is a schematic structural diagram in another perspective of a device used in a powdered adsorbent lossless recovery method based on a belt filter according to this disclosure;

FIG. 3 is a schematic structural diagram in another perspective of a device used in a powdered adsorbent lossless recovery method based on a belt filter according to this disclosure;

FIG. 4 is an enlarged view of a portion A in FIG. 3;

FIG. 5 is a schematic structural diagram of a hoister in FIG. 1; and

FIG. 6 is a schematic diagram of a flushing direction of a flushing pipe in FIG. 5.

### DETAILED DESCRIPTION

The following further describes the technical solution of this disclosure in detail with reference to the drawings and embodiments.

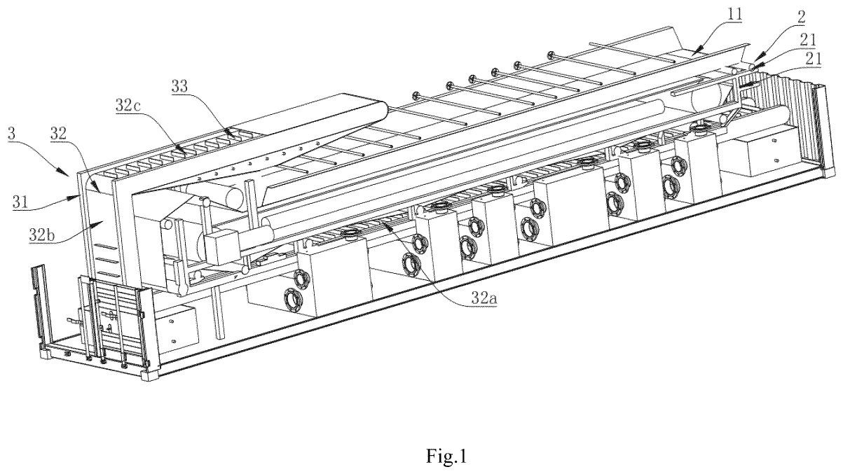

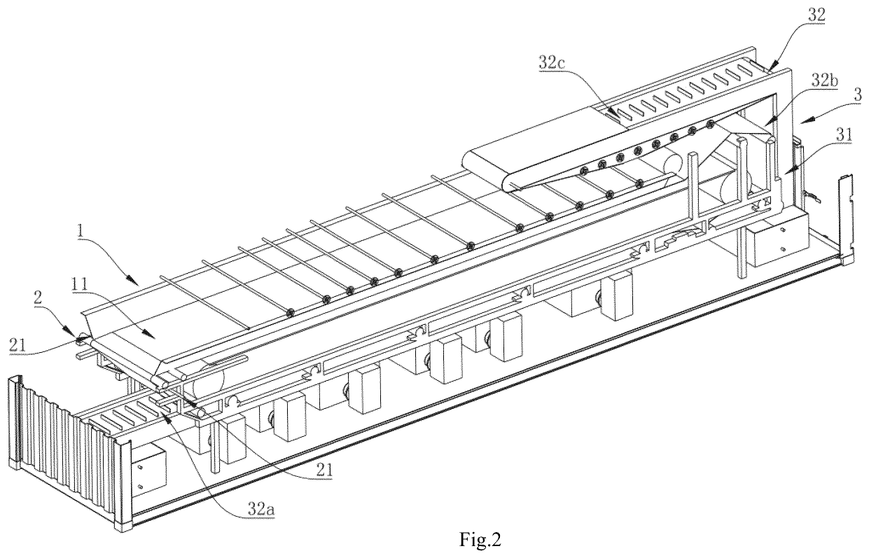

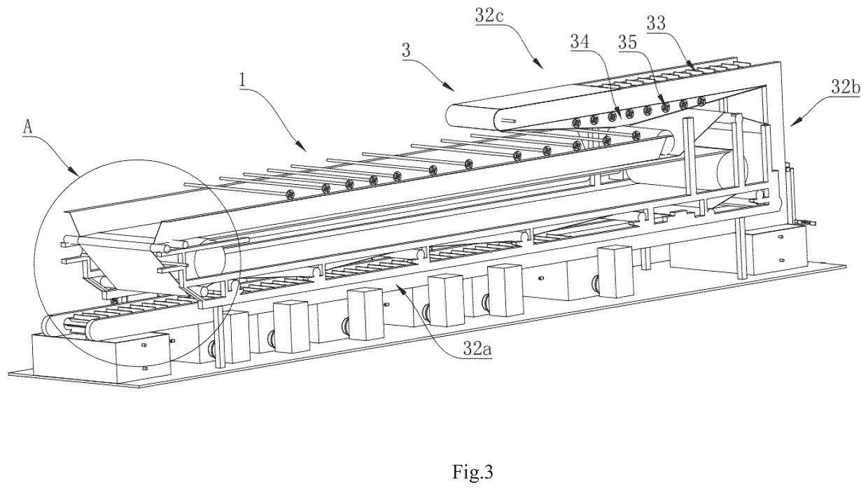

A powdered adsorbent lossless recovery method based on a belt filter 1 is provided. The method is performed on a device shown in FIG. 1, FIG. 2, and FIG. 3, and includes the following steps:

Collect a powdered adsorbent at the tail end of the belt filter 1.

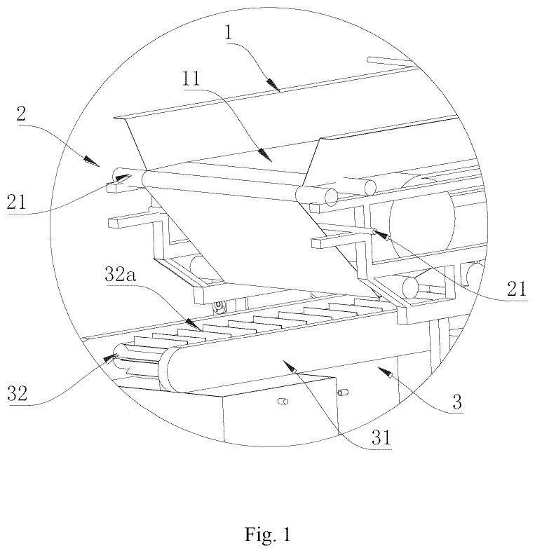

As shown in FIG. 4, with reference to FIG. 2 and FIG. 3, a gas-water mixture distributor 2 is disposed at the tail end of the belt filter 1, and the gas-water mixture distributor 2 includes at least one distribution pipe 21; a filter cloth 11 rotates at the tail end of the belt filter 1, at least one distribution pipe 21 is disposed at a rotation position of the filter cloth 11 or on a rotation path of the filter cloth 11, these distribution pipes 21 are located on an inner side of the filter cloth 11, and may be only close to or press against the filter cloth 11, or may directly participate in tensioning of the filter cloth 11, each distribution pipe 21 is provided with a plurality of distribution holes for spraying a gas-water mixture fluid to the filter cloth 11, and the number of the distribution holes is preferably the number that the spraying amount of the distribution holes can cover the width of the entire filter cloth 11; and the gas-water mixture fluid sprayed from the distribution holes may be sprayed intermittently or continuously, or may be may be sprayed intermittently and continuously, which is not required in this embodiment.

In this embodiment, the gas-water mixture fluid includes a gas and a liquid, the gas is air, the liquid is a stock solution (the same as a stock solution processed at the head end of the belt filter 1), and flow rates of the gas and the liquid are shown in Table 1.

The flushed powdered adsorbent is collected below the belt filter 1.

Convey the collected powdered adsorbent to a head end of the same belt filter 1 by using a hoister 3.

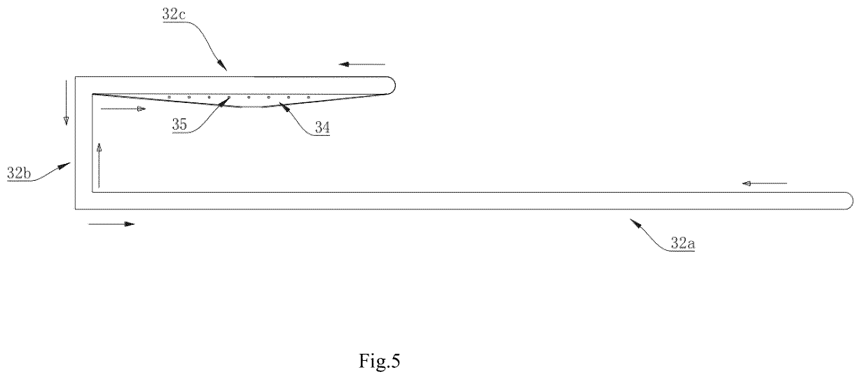

To recover the powdery adsorbent, the hoister 3 is disposed in a half-enclosed manner on an outer circumference of the belt filter 1. As shown in FIG. 5, with reference to FIG. 1 to FIG. 3, the hoister 3 includes a rack 31 and a conveyor belt 32 that runs cyclically on the rack 31. According to different locations, the conveyor belt 32 includes a return section 32a below the belt filter 1, a reuse section 32c above the head end of the belt filter 1, and a hoisting section 32b connected to the return section 32a and the reuse section 32c. A running direction of the return section 32a (which refers to a side facing the belt filter 1) is consistent with a rotation direction of the belt filter 11, the hoisting section 32b is a vertical hoisting section 32b, and a running direction of the reuse section 32c (which refers to a side facing the belt filter 1) is consistent with a forward direction of the belt filter 11.

Because the hoisting section 32b is vertically hoisted, a plurality of material stoppers 33 sequentially arranged in a running direction of the conveyor belt 32 are disposed on a surface of the conveyor belt 32, and each material stopper 33 forms an included angle, optionally 30° to 60°, with the conveyor belt 32. In this embodiment, there is no special requirement for the included angle, to forming material accumulation troughs between the material stoppers and the conveyor belt, so that the conveyor belt 32 can vertically hoist a suspension of the powdered adsorbent.

In this embodiment, a running speed of the filter cloth 11 may be set to 0.5 m/min to 3 m/min, and a running speed of the conveying belt 32 is greater than 5 m/min; and a proper running speed of the filter cloth 11 is for avoiding cross-flow of water between work sections (a solid-liquid separation zone, a smoke removal zone, and a desorption zone) of the belt filter 1, and the high running speed of the conveyor belt 32 can improve recovery efficiency of the adsorbent.

Separate the powdered adsorbent from the hoister 3.

In order to prevent the powdered adsorbent suspension on the hoisting section 32b from losing after entering the reuse section 32c, as shown in FIG. 5, a collection hopper 34 is disposed on the rack 31 at the head end of the belt filter 1, and the top opening width of the collection hopper 34 is equivalent to the length of the reuse section 32c, to receive the powdery adsorbent suspension dropped from the reuse section 32c.

Similarly, in order prevent the powdered adsorbent from sticking and remaining on the conveyor belt 32, a flushing pipe 35 for flushing the powdered adsorbent from the reuse section 32c is disposed on the collection hopper 34. There is no limitation on the number of the flushing pipes 35 in this embodiment. A flushing fluid used by the flushing pipe 35 can be a liquid (for example, a stock solution) or a gas-water mixture fluid, which is not required in this embodiment.

It should be noted that, because the material stoppers 33 are disposed on the surface of the conveyor belt 32, it is necessary to pay more attention to a flushing angle of the flushing pipe 35, and flushing directions of different flushing pipes 35 may be the same or different, that is, the flushing direction of at least one flushing pipe 35 needs to be opposite to the running direction of the conveyor belt 32, so as to flush the material accumulation troughs as much as possible.

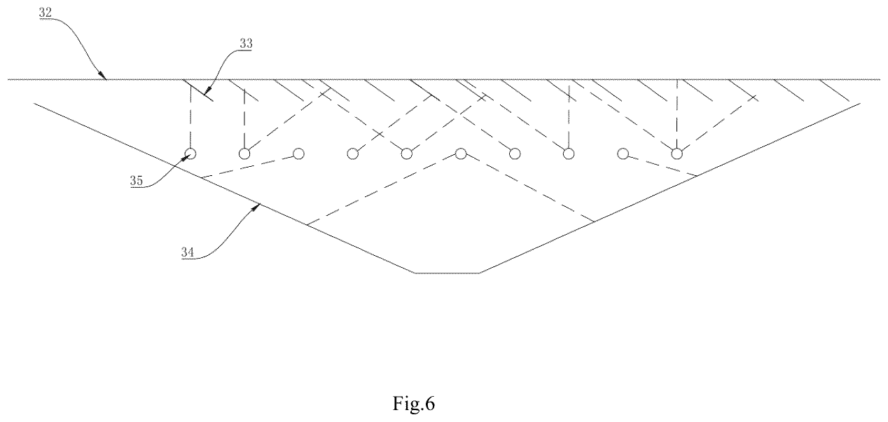

In a relatively preferred case, as shown in FIG. 6, according to statistics, all flushing holes disposed on each flushing pipe 35 have three flushing directions in total: a direction opposite to the running direction of the conveyor belt 32, a direction perpendicular to the conveyor belt 32, and a direction the same as the running direction of the conveyor belt 32. In this way, the inside of the material accumulation troughs and two sides of the material stoppers 33 can be adequately flushed.

Similarly, the flushing pipe 35 used to flush an inner wall of the collection hopper 34 may also have a plurality of different flushing directions.

It is clear that flushing holes with different flushing directions may be disposed on one flushing pipe 35 at the same time, or may be distributed on different flushing pipes 35, which is not specifically required in this embodiment.

TABLE 1

| | Gas | Liquid | Fluid | Adsorbent |
|---|---|---|---|---|
| Embodiment | flow rate | flow rate | pressure | recovery |
| number | (m³/h) | (m³/h) | (MPa) | rate (%) |
| Embodiment 1 | 0.2 | 2 | 0.500 | 95.5 |
| Embodiment 2 | 0.3 | 0.8 | 0.404 | 96.2 |
| Embodiment 3 | 0.3 | 1.5 | 0.520 | 99.5 |
| Embodiment 4 | 0.4 | 1.0 | 0.480 | 99.2 |
| Embodiment 5 | 0.5 | 1.0 | 0.540 | 99.1 |
| Embodiment 6 | 0.5 | 0.8 | 0.524 | 99.0 |
| Embodiment 7 | 0.5 | 1.2 | 0.584 | 99.8 |
| Embodiment 8 | 0.5 | 1.0 | 0.580 | 99.6 |
| Comparative | / | 1.0 | 0.200 | 85.5 |
| example 1 | | | | |
| Comparative | / | 5.0 | 0.4 | 99.0 |
| example 2 | | | | |
| Comparative | 0.7 | / | 0.580 | 65.7 |
| example 3 | | | | |

It can be learned from the data in Table 1 that reasonable matching of the gas flow rate and the liquid flow rate has a significant effect on the adsorbent recovery rate. In Embodiments 1 to 8, a high adsorbent recovery rate of 95.5% to 99.8% is achieved by adjusting a ratio of the gas flow rate to the liquid flow rate (0.2 m³/h to 0.5 m³/h for the gas and 0.8 m³/h to 2 m³/h for the liquid) and controlling the pressure in a range of 0.404 MPa to 0.584 MPa. Particularly in Embodiment 7, a peak recovery rate of 99.8% is obtained at a gas flow rate 0.5 m³/h, a liquid flow rate 1.2 m³/h, and a pressure 0.584 MPa, which indicates that an appropriate increase in a liquid phase ratio helps enhance mass transfer efficiency. Comparative experiments show that recovery rates in single-phase systems (no gas in Comparative example 1 or no liquid in Comparative example 3) decrease to 85.5% and 65.7%, respectively, which proves the key of gas-liquid synergy. When a single-phase liquid system is used, to achieve an adsorbent recovery rate of more than 99.0%, a liquid flow rate of more than 5.0 m³/h needs to be reached (see Comparative example 2), which causes excessive water content of the flushed adsorbent suspension.

1. A powdered adsorbent lossless recovery method based on a belt filter, comprising a first separation step of collecting a powdered adsorbent at a tail end of a belt filter, wherein the first separation step comprises flushing a filter cloth with at least a gas-water mixture fluid to separate the powdered adsorbent from the filter cloth.

2. The powdered adsorbent lossless recovery method according to claim 1, wherein a gas-water mixture distributor is configured to distribute the gas-water mixture fluid to the filter cloth, the gas-water mixture distributor comprises at least one distribution pipe, the distribution pipe is disposed on a rotation path of the filter cloth and is located on an inner side of the filter cloth, and a plurality of distribution holes for spraying the gas-water mixture fluid to the filter cloth are disposed on the distribution pipe.

3. The powdered adsorbent lossless recovery method according to claim 1, wherein in the gas-water mixture fluid, a gas flow rate is 0.2 m³/h to 0.5 m³/h, and a liquid flow rate is 0.8 m³/h to 2.0 m³/h.

4. The powdered adsorbent lossless recovery method according to claim 1, wherein a gas in the gas-water mixture fluid is compressed air; and a liquid in the gas-water mixture fluid is a stock solution or a desorption solution.

5. The powdered adsorbent lossless recovery method according to claim 1, further comprising: a hoisting step of conveying the collected powdered adsorbent to a head end of the same belt filter by using a hoister.

6. The powdered adsorbent lossless recovery method according to claim 2, further comprising: a hoisting step of conveying the collected powdered adsorbent to a head end of the same belt filter by using a hoister.

7. The powdered adsorbent lossless recovery method according to claim 3, further comprising: a hoisting step of conveying the collected powdered adsorbent to a head end of the same belt filter by using a hoister.

8. The powdered adsorbent lossless recovery method according to claim 4, further comprising: a hoisting step of conveying the collected powdered adsorbent to a head end of the same belt filter by using a hoister.

9. The powdered adsorbent lossless recovery method according to claim 5, wherein the hoister comprises a rack and a conveyor belt that runs cyclically on the rack; the conveyor belt comprises a return section below the belt filter, a reuse section above ahead end of the belt filter, and a hoisting section connected to the return section and the reuse section; and a running direction of the return section is consistent with a rotation direction of the filter cloth, and a running direction of the reuse section is consistent with a forward direction of the filter cloth.

10. The powdered adsorbent lossless recovery method according to claim 6, wherein the hoister comprises a rack and a conveyor belt that runs cyclically on the rack; the conveyor belt comprises a return section below the belt filter, a reuse section above a head end of the belt filter, and a hoisting section connected to the return section and the reuse section; and a running direction of the return section is consistent with a rotation direction of the filter cloth, and a running direction of the reuse section is consistent with a forward direction of the filter cloth.

11. The powdered adsorbent lossless recovery method according to claim 7, wherein the hoister comprises a rack and a conveyor belt that runs cyclically on the rack; the conveyor belt comprises a return section below the belt filter, a reuse section above a head end of the belt filter, and a hoisting section connected to the return section and the reuse section; and a running direction of the return section is consistent with a rotation direction of the filter cloth, and a running direction of the reuse section is consistent with a forward direction of the filter cloth.

12. The powdered adsorbent lossless recovery method according to claim 8, wherein the hoister comprises a rack and a conveyor belt that runs cyclically on the rack; the conveyor belt comprises a return section below the belt filter, a reuse section above a head end of the belt filter, and a hoisting section connected to the return section and the reuse section; and a running direction of the return section is consistent with a rotation direction of the filter cloth, and a running direction of the reuse section is consistent with a forward direction of the filter cloth.

13. The powdered adsorbent lossless recovery method according to claim 9, wherein a plurality of material stoppers sequentially arranged in a running direction of the conveyor belt are disposed on a surface of the conveyor belt, material accumulation troughs are formed between the material stoppers and the conveyor belt, and an included angle between each of the material stoppers and the conveyor belt is 30° to 60°.

14. The powdered adsorbent lossless recovery method according to claim 10, wherein a plurality of material stoppers sequentially arranged in a running direction of the conveyor belt are disposed on a surface of the conveyor belt, material accumulation troughs are formed between the material stoppers and the conveyor belt, and an included angle between each of the material stoppers and the conveyor belt is 30° to 60°.

15. The powdered adsorbent lossless recovery method according to claim 11, wherein a plurality of material stoppers sequentially arranged in a running direction of the conveyor belt are disposed on a surface of the conveyor belt, material accumulation troughs are formed between the material stoppers and the conveyor belt, and an included angle between each of the material stoppers and the conveyor belt is 30° to 60°.

16. The powdered adsorbent lossless recovery method according to claim 12, wherein a plurality of material stoppers sequentially arranged in a running direction of the conveyor belt are disposed on a surface of the conveyor belt, material accumulation troughs are formed between the material stoppers and the conveyor belt, and an included angle between each of the material stoppers and the conveyor belt is 30° to 60°.

17. The powdered adsorbent lossless recovery method according to claim 9, wherein a running speed of the filter cloth is 0.5 m/min to 3 m/min, and a running speed of the conveyor belt is greater than 5 m/min.

18. The powdered adsorbent lossless recovery method according to claim 9, wherein a collection hopper for receiving the powdered adsorbent dropped from the reuse section is disposed on the rack at the head end of the belt filter; and a flushing pipe for flushing the powdered adsorbent from the reuse section and/or the collection hopper is disposed on the collection hopper.

19. The powdered adsorbent lossless recovery method according to claim 5, further comprising a second separation step of separating the powdered adsorbent from the hoister, wherein the conveyor belt of the hoister is flushed with at least a liquid or the gas-water mixture fluid in the second separation step.
